(19) United States
(12) Patent Application Publication
(10) Pub. No.: US 2026/0313719 A1
(43) Pub. Date: Oct. 8, 2026

(54) SYSTEMS AND METHODS FOR ESTABLISHING A PRIORITIZED WIRELESS LOCAL AREA NETWORK CONNECTION USING CELLULAR CORE NETWORK SERVICES

(71) Applicant: Verizon Patent and Licensing Inc., Basking Ridge, NJ (US)

(72) Inventors: Chien-Yuan HUANG, Basking Ridge, NJ (US); Toby Varughese JOHN, Murphy, TX (US)

(73) Assignee: Verizon Patent and Licensing Inc., Basking Ridge, NJ (US)

(21) Appl. No.: 19/173,095

(22) Filed: Apr. 8, 2025

(51) Int. Cl. H04W 76/10; H04L 67/02; H04W 12/0471; H04W 84/12

(52) U.S. Cl. CPC H04W 76/10; H04L 67/02; H04W 12/0471; H04W 84/12

(57) ABSTRACT

In some implementations, a gateway device may receive a priority wireless local area network (WLAN) connection request that indicates a request to establish a priority connection with a user equipment (UE) based at least in part on a requested priority. The gateway device may send a first message that is based at least in part on the priority WLAN connection request and indicates at least the request and the requested priority. The gateway device may receive a second message that indicates an acknowledgment of the request and an assigned priority. The gateway device may create a diameter message routing priority (DMRP) that is based at least in part on the assigned priority. The gateway device may establish the priority WLAN connection request based at least in part on communications with a core network and the DMRP.

### BACKGROUND

Multimedia Priority Service (MPS) is a telecommunications service that allows for preferential or prioritized access to mobile network resources. Providing prioritized access may enable a network to establish and maintain critical communications (e.g., voice communications, video communications, and data communications) more reliably, even in scenarios with high network congestion. To illustrate, MPS may process higher-priority communications more quickly relative to standard network traffic, may allocate more bandwidth to the higher-priority communications relative to standard network traffic, and/or may use dedicated network resources for the higher-priority communications. The use of MPS may result in lower latency, increased bandwidth availability, and reduced packet loss for the prioritized communications.

### BRIEF DESCRIPTION OF THE DRAWINGS

FIGS. 1A-1I illustrate diagrams of an example environment in which systems and/or methods described herein may be implemented.

FIGS. 2A and 2B collectively illustrate an example of a call flow diagram for establishing a prioritized wireless local area network (WLAN) connection using services provided by a cellular core network.

FIG. 3 is a diagram of an example environment in which systems and/or methods described herein may be implemented.

FIG. 4 is a diagram of example components of a device associated with establishing a prioritized WLAN connection using cellular core network services.

FIG. 5 is a flowchart of an example process associated with establishing a prioritized WLAN using cellular core network services.

FIG. 6 is a flowchart of an example process associated with establishing a prioritized WLAN connection using cellular core network services.

### DETAILED DESCRIPTION OF EXAMPLE EMBODIMENTS

The following detailed description of example implementations refers to the accompanying drawings. The same reference numbers in different drawings may identify the same or similar elements.

Priority services in telecommunications are designed to ensure that prioritized communications are given precedence over standard communications. Example priority services include Emergency Priority Communications Service (EPCS) and MPS. To illustrate, some priority services may assign higher priority levels to specific types of communications that enable a network infrastructure to recognize the higher priority level and process the higher-priority communication, such as by giving precedence to the higher-priority communications over lower-priority communications (e.g., regular data traffic). For instance, the network infrastructure may move the high-priority communication (e.g., from a first responder) to a front of a transmission queue and ahead of a low-priority communication (e.g., Internet browser data traffic) to ensure that the high-priority communication is delivered in a timely and reliable manner. In some cases, a subscriber may obtain a high-priority status or gain access to a priority service through a network service provider that is associated with the network infrastructure.

In some cases, a user equipment (UE) may access one or more services provided by a core network of a cellular network using a WLAN connection, such as a Wi-Fi connection. To illustrate, the UE may initiate a connection request to a gateway device (e.g., an evolved packet data gateway (ePDG)), and the gateway device may communicate with the core network to validate that the UE has the proper credentials to gain access to the core network. Based at least in part on the core network providing successful validation, the gateway device may establish a connection with the UE and act as an intermediary between the UE and the core network, resulting in the UE gaining access to some network services via the WLAN connection.

Although a UE may access some core network services via a WLAN connection, not all services provided by the core network infrastructure may be supported for the WLAN connection. As one example, priority services at the core network may use specific protocols and mechanisms that are not fully compatible with the WLAN infrastructure. To illustrate, a first WLAN mechanism used by the UE to indicate priority information that is associated with a priority service or request a priority service may be incompatible with a second mechanism used by the core network to process priority information, authenticate a subscription, and/or manage a session for the UE with the appropriate priority. Additionally, the core network infrastructure and/or a gateway device may lack support to prioritize WLAN communications. For instance, the UE may request to establish an Internet protocol security (IPsec) tunnel via a WLAN connection with a gateway device in the form of an ePDG of a core network, where the request indicates a requested priority for the IPsec tunnel. However, the ePDG may process all IPsec tunnels equally and without considering a priority level of the communications (e.g., data traffic) carried via each IPsec tunnel. The lack of support in the gateway device to provide priority services for a WLAN connection may result in suboptimal resource allocation and failure to meet one or more operating conditions (e.g., a time-based operating condition, tiered prioritization based on a user categorization, communication type priority, or service provider agreements) associated with providing prioritized service.

Some implementations described herein provide a method for establishing priority-based WLAN connections using priority services from a core network. In some aspects, a gateway device (e.g., an ePDG) may receive a priority WLAN connection request (e.g., an MPS message) via a WLAN connection, and the priority WLAN connection request may indicate a request to establish a priority WLAN connection request with a UE based at least in part on a requested priority. For instance, the UE may establish a WLAN connection with the ePDG, and may transmit a request for a priority service connection via the WLAN connection. Based at least in part on receiving the priority WLAN connection request, the gateway device may send, to a core network, a first message that indicates the request to establish the MPS connection, a requested priority for the MPS connection, or both. As one example, the gateway device may send a first diameter message. “Diameter message” may denote a network protocol message that is used for authentication, authorization, and accounting (AAA) services in a telecommunications network. Based at least in part on sending the first message, the gateway device may receive a second message (e.g., a second diameter message) that indicates an acknowledgment to the request. Alternatively, or additionally, the second message may indicate an assigned priority that may be the same priority as the requested priority or may be a different priority than the requested priority. In some aspects, the gateway device may create a diameter message routing priority (DMRP) that is associated with the priority WLAN connection based at least in part on the assigned priority, and may establish the priority WLAN connection with the UE based at least in part on communications with a core network and the DMRP. To illustrate, the gateway device may establish the priority WLAN connection by communicating with the core network using General Packet Radio Service tunneling protocol version 2 (GTPv2) communications.

In some aspects, a core network may receive a hypertext transfer protocol (HTTP) message that indicates a request for a priority WLAN connection (e.g., an MPS connection) with a UE, where the priority WLAN connection is based at least in part on a WLAN connection, such as a WLAN connection between the UE and an ePDG of the core network. As one example, the core network may receive the HTTP message using a service-based interface (SBI). “Service-based interface” denotes a communication model used by network functions (NFs) (e.g., core network functions) to interact with one another, such as through HTTP messages. In some cases, the HTTP message may indicate a UE identifier that is associated with the UE, a requested priority for the priority WLAN connection, or both. Based at least in part on receiving the request for the priority WLAN connection, the core network may retrieve subscription data that is associated with the UE, such as by using the UE identifier indicated in the request message. Alternatively, or additionally, the core network may derive an assigned priority for the priority WLAN connection based at least in part on the requested priority, the subscription data, or both. For instance, the subscription data may indicate a maximum priority level that is assigned to the UE, and the maximum priority level may be lower than the requested priority such that the core network derives the assigned priority as the maximum priority level. As another example, the maximum priority level indicated by the subscription data may be higher than the requested priority such that the core network derives the assigned priority as the requested priority level. In some aspects, the core network may send a response message that indicates the assigned priority, an indication of an authentication status for the UE, or both. As one example, the core network may send the response message as another HTTP message.

A gateway device, such as an ePDG, may enable a priority-based WLAN connection using core network priority services by creating a DMRP for the priority-based WLAN connection using priority information from a core network. Alternatively, or additionally, the gateway device may process priority-based communications associated with the priority-based WLAN connection using the DMRP in combination with GTPv2 communications with the core network. The use of DMRP in combination with GTPv2 may enable the gateway device to give precedence to the priority-based communications that are received or sent via the priority-based WLAN connection (e.g., communications from or for first responders) relative to standard communications, resulting in an increased reliability and an increased timeliness of the priority-based communications, even during network congestion. That is, the gateway device may process the priority-based WLAN connections (e.g., IPsec tunnels) based at least in part on an assigned priority indicated by the core network, resulting in mitigating suboptimal resource allocation and increasing an efficiency in resource allocation at the gateway device, may enable the gateway device to successfully meet one or more operating conditions associated with the priority connection (e.g., a time-based operating condition and/or a tiered prioritization operating condition that is based at least in part on any combination of a user categorization, a communication type priority, or service provider agreements). The use of network protocol messages for establishing a priority-based WLAN connection, and processing communications through the priority-based WLAN connection, may also enable the gateway device to leverage authentication and priority assignment as provided by the core network, resulting in increased security in handling the communications.

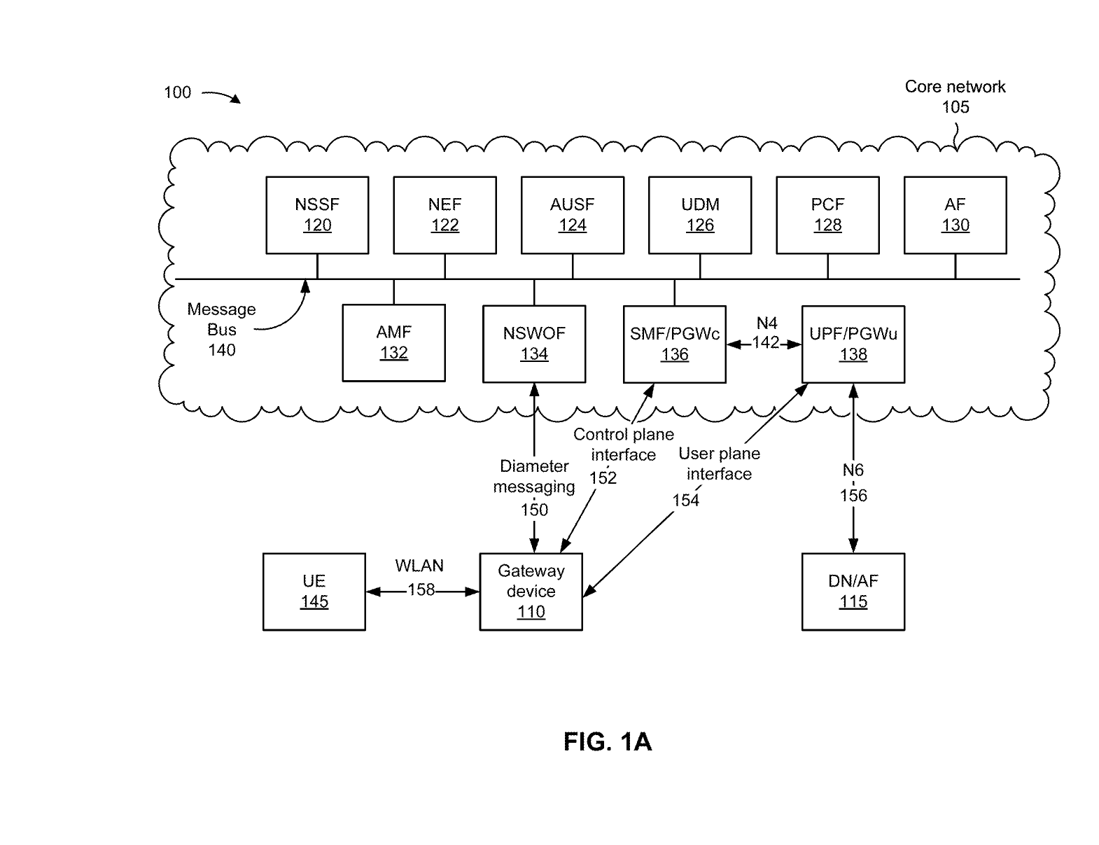

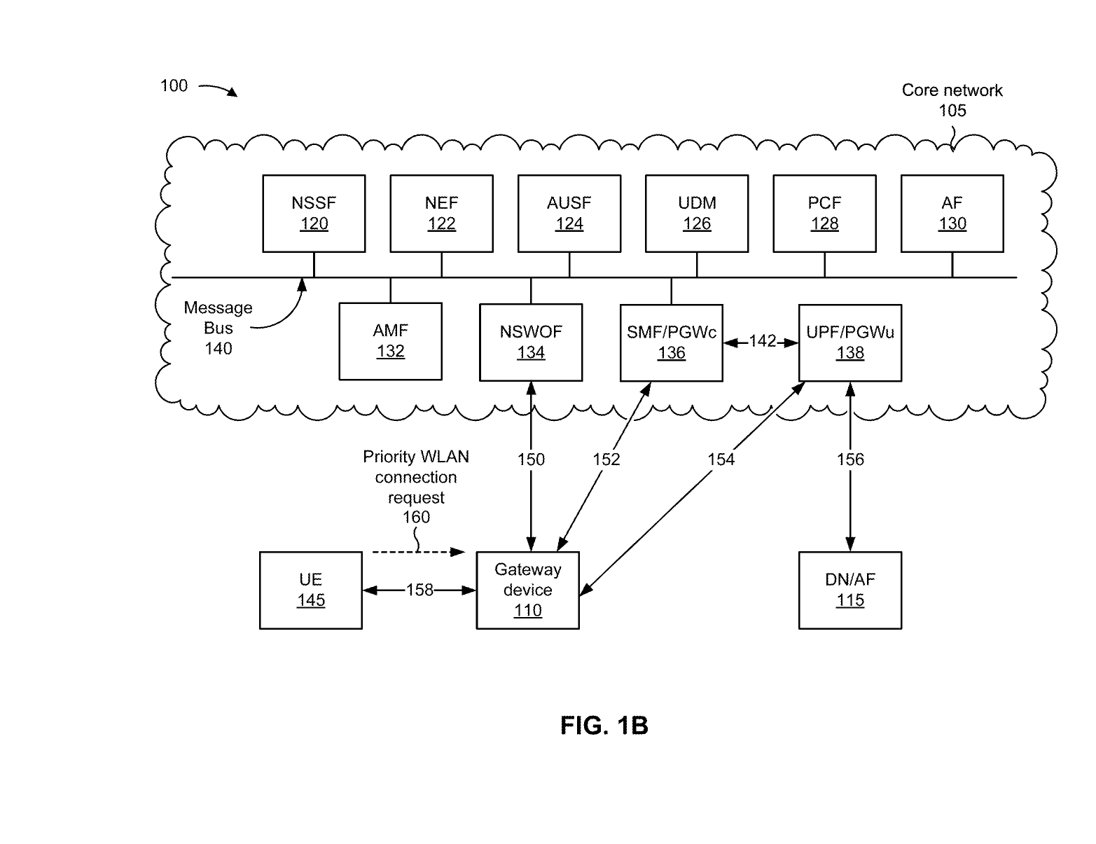

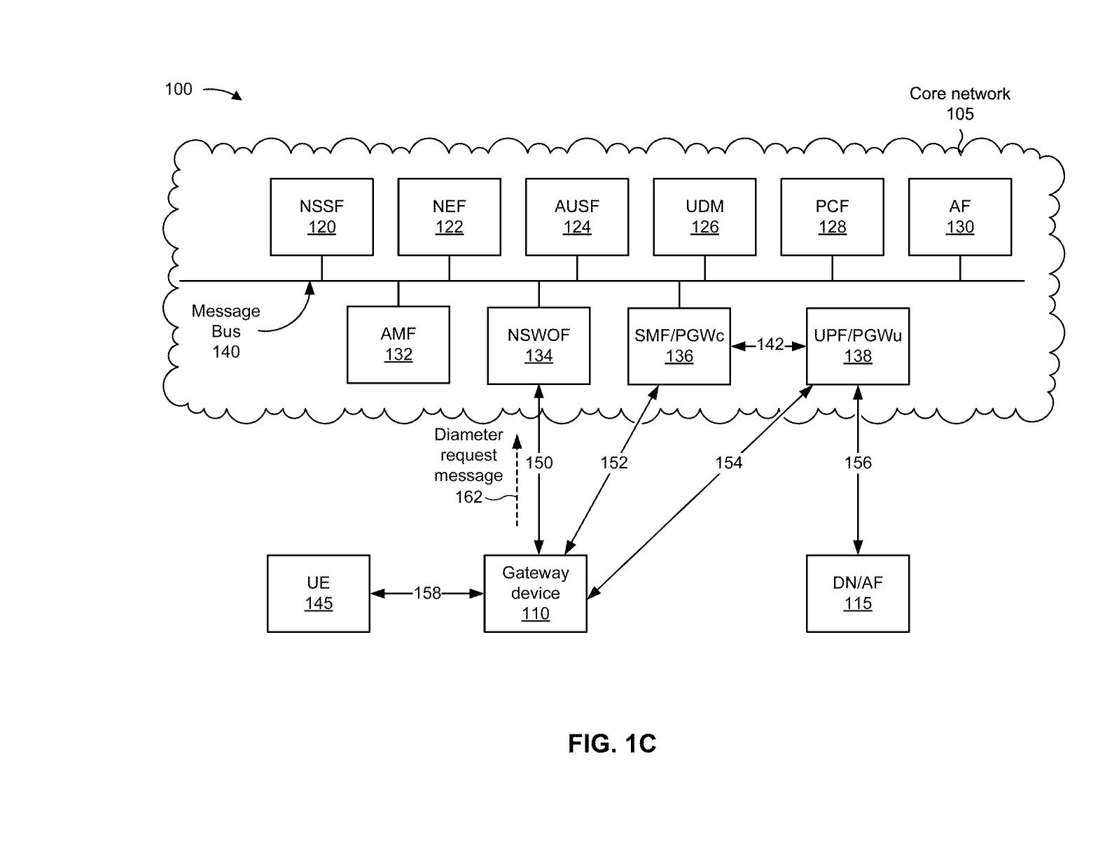

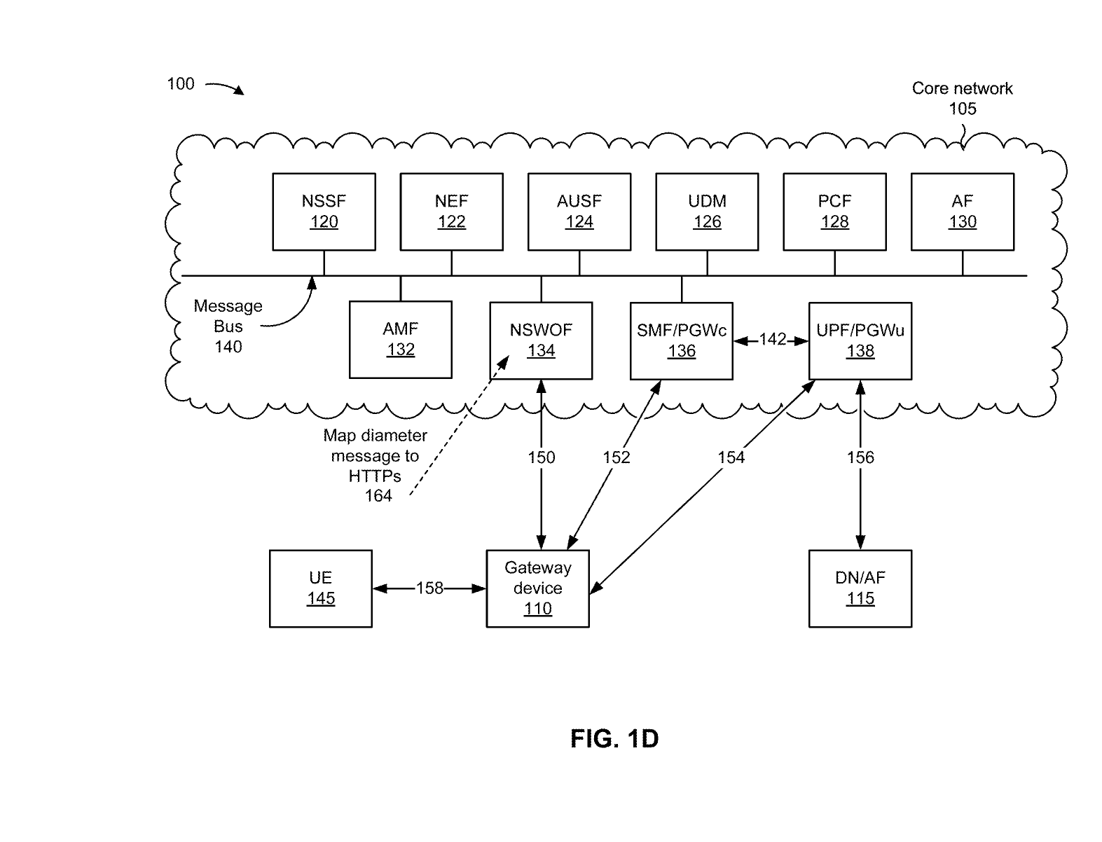

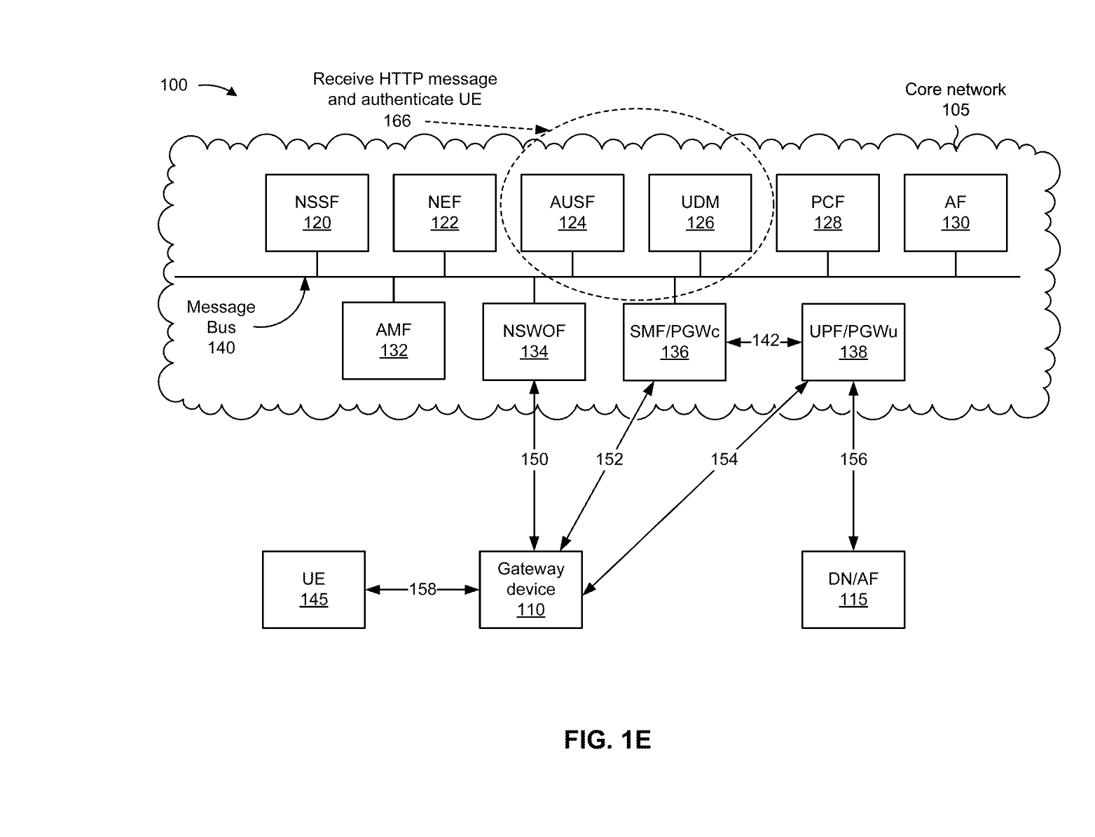

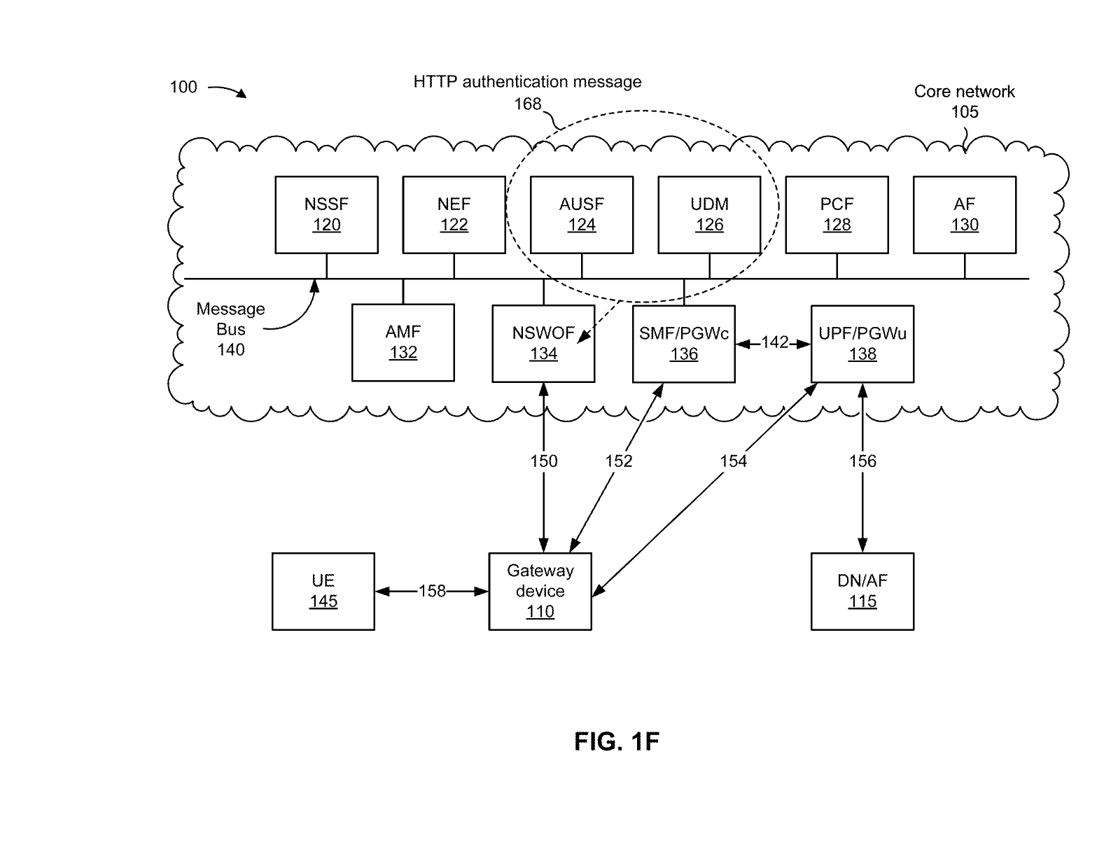

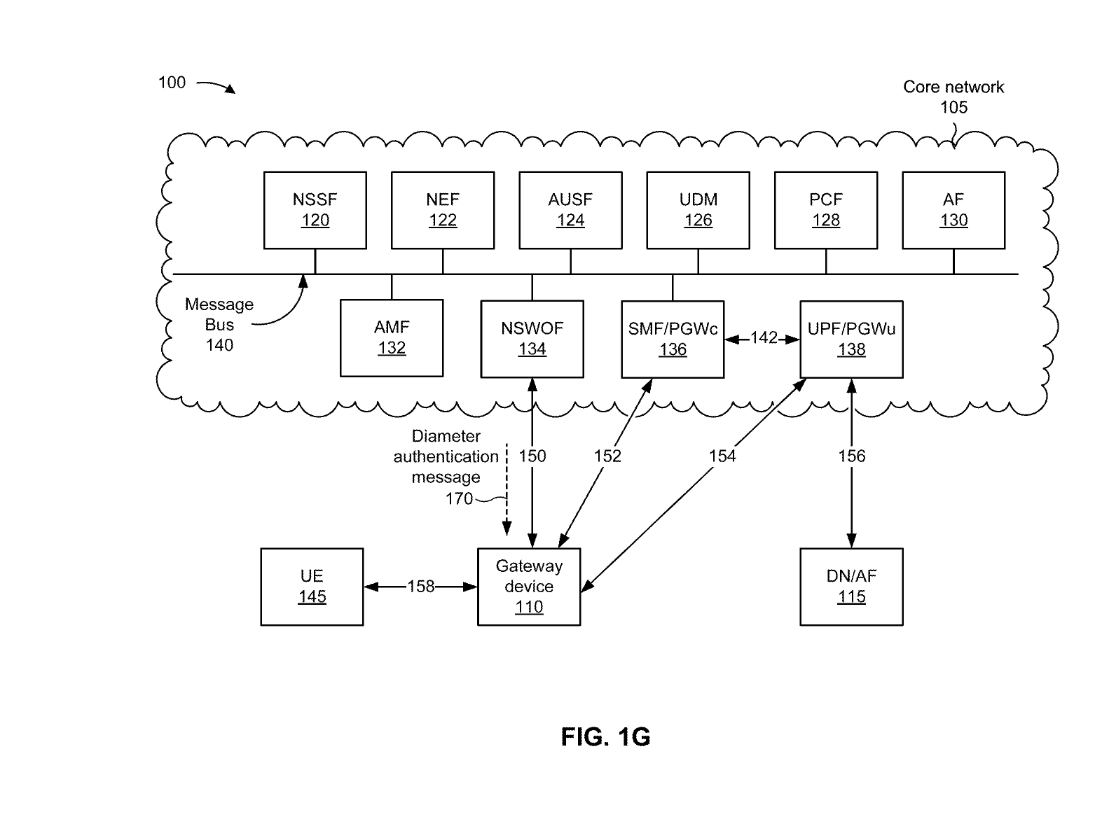

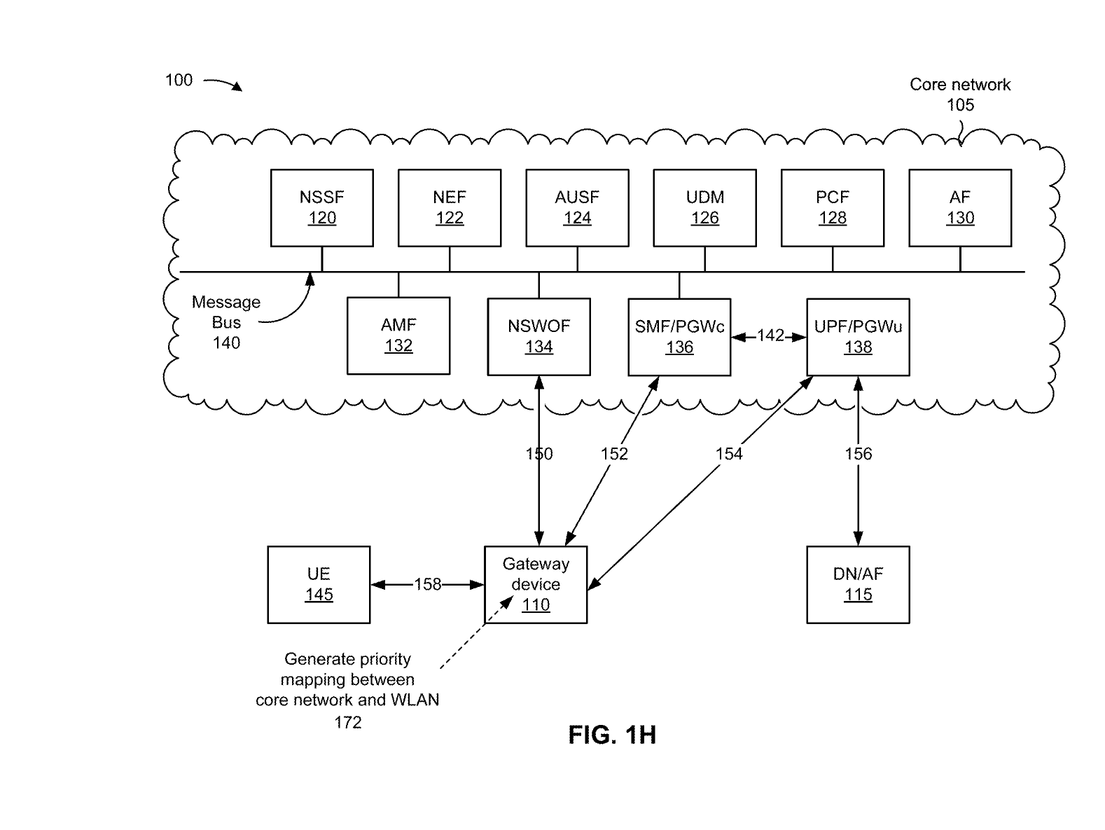

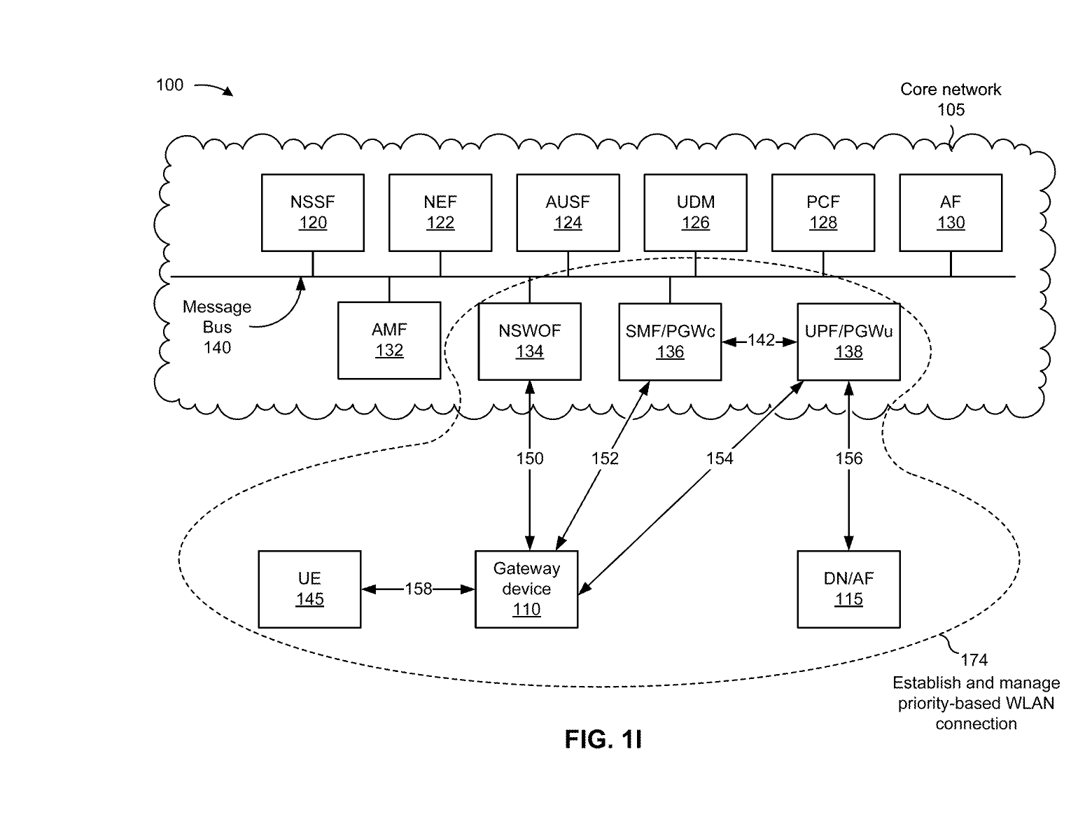

FIGS. 1A-1I illustrate diagrams of an example environment 100 in which systems and/or methods described herein may be implemented. As shown in FIG. 1A, the example environment 100 may include a core network 105, a gateway device 110, and a data network (DN)/application function (SF) 115. For visual clarity, the gateway device 110 is shown in FIG. 1A as being outside of the core network 105, but in some aspects, the gateway device 110 may be included in, and/or a part of, the core network 105. Devices and/or networks of example environment 100 may interconnect via wired connections, wireless connections, or a combination of wired and wireless connections.

In some implementations, core network 105 may include an example functional architecture in which systems and/or methods described herein may be implemented. For example, core network 105 may include an example architecture of a fifth generation (5G) next generation (NG) core network included in a 5G wireless telecommunications system. While the example architecture of core network 105 shown in FIG. 1A may be an example of a service-based architecture, in some implementations, core network 105 may be implemented as a reference-point architecture and/or a 4G core network, among other examples.

As shown in FIG. 1A, core network 105 may include a number of functional elements. The functional elements may include, for example, a network slice selection function (NSSF) 120, a network exposure function (NEF) 122, an authentication server function (AUSF) 124, a unified data management (UDM) component 126, a policy control function (PCF) 128, an application function (AF) 130, an access and mobility management function (AMF) 132, a non-seamless WLAN offload function (NSWOF) 134, a session management function (SMF) 136 that may include packet gateway control plane (PGWc) functionality, and/or a user plane function (UPF) 138 that may include packet gateway user plane (PGWu) functionality. These functional elements may be communicatively connected via a message bus 140, and the functional elements may communicate with one another using the message bus and an SBI. The SBI may be integrated with the message bus based at least in part on using a service communication proxy (SCP) that acts as an intermediary for routing, load balancing, and caching SBI messages. Each of the functional elements of the core network 105 shown in FIG. 1 may be implemented on one or more devices associated with a wireless telecommunications system. In some implementations, one or more of the functional elements may be implemented on physical devices, such as an access point, a base station, and/or a gateway (e.g., the gateway device 110). In some implementations, one or more of the functional elements may be implemented on a computing device of a cloud computing environment.

NSSF 120 includes one or more devices that enable the NSSF 120 to select network slice instance(s) for a UE 145. By providing network slicing, NSSF 120 allows an operator to deploy multiple substantially independent end-to-end networks potentially with the same infrastructure. In some implementations, each slice may be customized for different services.

NEF 122 includes one or more devices that support exposure of capabilities and/or events in the wireless telecommunications system to help other entities in the wireless telecommunications system discover network services.

AUSF 124 includes one or more devices that act as an authentication server and support the process of authenticating UE 145 in the wireless telecommunications system.

UDM 126 includes one or more devices that store user data and profiles in the wireless telecommunications system. UDM 126 may be used for fixed access and/or mobile access in core network 105.

PCF 128 includes one or more devices that provide a policy framework that incorporates network slicing, roaming, packet processing, and/or mobility management, among other examples.

AF 130 includes one or more devices that support application influence on traffic routing, access to NEF 122, and/or policy control, among other examples.

AMF 132 includes one or more devices that act as a termination point for non-access stratum (NAS) signaling and/or mobility management, among other examples.

NSWOF 134 manages offloading traffic from cellular networks to alternative wireless networks (e.g., a WLAN) in a non-standardized way. Functionality provided by the NSWOF 134 may vary from network operator to network operator, with an emphasis on optimizing network traffic and reducing congestion within the cellular network by using available offload paths. In some cases, the NSWOF 134 manages a gap in communications between the gateway device 110 and the core network 105. For instance, the NSWOF 134 may perform translation between diameter-based messages (e.g., used by the gateway device 110) and HTTP messages (e.g., used by the core network 105), resulting in the gateway device 110 and the core network 105 being able to communicate with seamless connectivity and proper prioritization of services.

SMF/PGWc 136 includes one or more devices that support the establishment, modification, and release of communication sessions in the wireless telecommunications system. For example, SMF/PGWc 136 may configure traffic steering policies at the UPF/PGWu 138 and/or may enforce user equipment Internet protocol (IP) address allocation and policies, among other examples. As shown by FIG. 1A, the SMF/PGWc 136 may communicate with the UPF/PGWu 138 using an N4 interface 142, where “N4” is a label specified by a communication standard.

UPF/PGWu 138 includes one or more devices that serve as an anchor point for intra-RAT and/or inter-RAT mobility. UPF 138 may apply rules to packets, such as rules pertaining to packet routing, traffic reporting, and/or handling user plane QoS, among other examples.

Message bus 140 represents a communication structure for communication among the functional elements. In other words, message bus 140 may permit communication between two or more functional elements.

DN/AF 115 includes one or more wired and/or wireless data networks. For example, DN/AF 115 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The gateway device 110 may communicate with the NSWOF 134 using diameter messaging 150. As one example, the gateway device 110 may use an IP-based transport connection with the NSWOF 134 to send and receive one or more diameter messages. Alternatively, or additionally, the gateway device 110 may communicate with the SMF/PGWc 136 using a control plane interface 152, such as an S2b control plane interface (where “S2b” is a label specified by a communication standard). In a similar manner, the gateway device 110 may communicate with the UPF/PGWu 138, such as via an S2b user plane interface.

The gateway device 110 may include one or more devices capable of facilitating, managing, and/or controlling network communications, such as communications described herein. For example, the gateway device 110 may be implemented as an ePDG, a wireless access point, a router, a network switch, a network bridge, a firewall, a network controller, or a similar type of network device. The gateway device 110 may be configured to handle various types of network traffic, including but not limited to, data traffic, voice traffic, and multimedia traffic. As shown by FIG. 1A, the gateway device 110 may communicate with the UE 145 using a WLAN connection 158, and may also interface with other network elements within the core network 105 as described above to provide prioritized network services.

The UPF/PGWu 138 may communicate with the DN/AF 115 using a fourth connection 156, such as an N6 interface, where “N6” is a label specified by a communication standard.

The UE 145 may include one or more devices capable of receiving, generating, storing, processing, and/or providing information, such as information described herein. For example, UE 145 may be implemented as a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device. As shown by FIG. 1A, the UE 145 may communicate with the gateway device 110 using the WLAN connection 158.

As shown by FIG. 1B and reference number 160, the UE 145 may transmit, and the gateway device 110 may receive, a priority WLAN connection request via the WLAN connection 158. For example, the UE 145 may transmit the priority WLAN connection request using the WLAN connection 158. In some cases, the priority WLAN connection request may indicate a requested priority for the priority WLAN connection and/or may indicate a type of priority WLAN connection to establish via the WLAN connection 158, such as an MPS connection or an EPCS connection, that is associated with one or more operating conditions for the priority WLAN connection. As one non-limiting example, the UE 145 may transmit an Internet Key Exchange (IKE) message, such as an IKE version 2 (IKEv2) message with MPS priority to the gateway device 110 via the WLAN connection 158, where an IKEv2 message with MPS priority is a security protocol message that includes priority information indicating a request for prioritized network access for critical communications.

In some aspects, the UE 145 may transmit the priority WLAN connection request based at least in part on user interaction or application operating conditions that prioritize the WLAN connection. For example, a first responder’s device may automatically transmit a request for a prioritized WLAN connection based at least in part on user input that accesses an emergency communication application. As another example, a video conferencing application may cause the UE 145 to transmit the priority WLAN connection request based at least in part on user input to start a video conference to ensure that the video conference is uninterrupted.

The priority WLAN connection request may implicitly or explicitly indicate a requested priority. As an example, the requested priority may be implicit based at least in part on a requested type of service indicated by the priority WLAN connection request (e.g., an emergency communication service type or a video conference communication service type). Alternatively, the priority WLAN connection request may include a field that is dedicated to carrying the requested priority explicitly.

In some cases, the UE 145 may receive input that implicitly indicates to request a priority WLAN connection. To illustrate, the UE 145 may receive input that is associated with a user dialing a specific mobile directory number (MD) such that the UE 145 triggers the transmission of a request for a priority WLAN connection request. As another example, the UE 145 may receive input that is associated with the user navigating to a particular uniform resource locator (URL) for authorized access to a distinguished name (DN) may trigger such that the computing device triggers the transmission of a request for a priority WLAN connection request. Alternatively, or additionally, the UE 145 may transition to operating in a priority status mode in response to receiving the input, and may include requested priority levels in a priority WLAN connection request based at least in part on operating in the priority status mode. The UE 145 may select the requested priority based at least in part on subscription information stored at the UE 145 and/or may be a pre-configured setting for an application at the UE 145.

As shown by FIG. 1C and reference number 162, the gateway device 110 may send a first diameter request message that indicates a request for a priority WLAN connection (e.g., an MPS connection). To illustrate, the gateway device 110 may send the first diameter request message to the NSWOF 134 using an IP-based transport connection. In some aspects, the first diameter request message may indicate a requested priority for the priority WLAN connection, an identifier of the UE 145, or a combination of the two. Example identifiers may include one or more of a medium access control (MAC) address, an international mobile subscriber identity (IMSI), a temporary mobile subscriber identity (TMSI), an international mobile equipment identity (IMEI), subscriber identity module (SIM) information, or a public land mobile network (PLMN) identifier. In some aspects, the gateway device 110 may map information from the priority WLAN connection request to the first diameter request message to ensure standardized communication and interoperability between network elements. In some aspects, the gateway device 110 may map information from the priority WLAN connection request using one or more diameter routing message priority (DRMP) attribute-value pairs (AVPs) within the first diameter message. Example information that may be mapped includes the requested priority, a user identifier, or both, where a DRMP AVP is a data structure within a diameter message that specifies the priority of that message.

As shown by FIG. 1D and reference number 164, the NSWOF 134 may map information from the first diameter message to another message format, such as an HTTP message format, to ensure standardized communication and interoperability between other NFs of the core network. To illustrate, the NSWOF 134 may map information from the first diameter message to an HTTP message to ensure that the message is compatible and may be sent using the SBI within the core network 105 while preserving the original information from the first diameter message (and the priority WLAN connection request). As one example, the first diameter message may include a DRMP AVP that indicates the requested priority, and the NSWOF 134 may map the information indicated via the DRMP AVP to one or more corresponding fields in an HTTP message, thus ensuring that the priority information is accurately conveyed and preserved during the protocol translation. That is, the mapping by the NSWOF 134 may result in an HTTP message that carries the requested priority of the original priority WLAN connection request in a format that is supported by the SBI and other NFs in the core network.

Alternatively, or additionally, the HTTP message generated by the NSWOF 134 may include a UE identifier, an SBI message priority (MP) parameter, or both. The SBI MP parameter may be derived from the DRMP AVP as described above. For instance, the DRMP AVP in the first diameter message may indicate a high priority level (e.g., a value of 1, where lower numbers represent higher priority), and the NSWOF 134 may map the high priority level to an equivalent SBI MP value in the HTTP message. To illustrate, a DRMP AVP value of 1 may translate to an SBI MP value of “high” in the HTTP message.

In some aspects, the NSWOF 134 may use a predefined mapping scheme to convert one or more priority attributes from the first diameter message to one or more corresponding parameters in the HTTP message, ensuring that the MPS request’s priority is preserved throughout the communication process. To illustrate, the NSWOF 134 may map the requested priority indicated in the first diameter message to an “SBI Message Priority” parameter in the HTTP message, a quality-of-service (QoS) class identifier (QCI) indicated in the first diameter message to a “QoS Class” parameter in the HTTP message, an allocation and retention priority (ARP) indicated in the first diameter message to an “ARP Level” parameter in the HTTP message, a differentiated services code point (DSCP) indicated in the first diameter message to a “DSCP Value” parameter in the HTTP message, and/or one or more bearer resource command (BRC) parameters indicated in the first diameter message to “Bearer QoS Parameters” in the HTTP message. Examples of a predefined mapping scheme may include a predefined mapping scheme as specified by a communication standard, resulting in a consistent methodology for handling priority information by the NSWOF 134 and other NFs in the core network.

As shown by FIG. 1E and reference number 166, the NSWOF 134 may send, and one or more NFs of the core network 105 may receive, the HTTP message that indicates the UE identifier, the SBI MP parameter, or both. In some aspects, the HTTP message indicates a request for establishing a priority connection, such as an MPS connection, and the NF(s) may use the information carried in the HTTP message (e.g., the UE identifier and/or SBI MP) to process the request. For instance, the NF(s) may use the UE identifier to authenticate the UE 145 and/or may use the SBI MP parameter verify that the UE 145 has access to the requested priority service.

To illustrate, the NSWOF 134 may send the HTTP message to the AUSF 124, and the AUSF 124 may communicate with the UDM 126 to retrieve subscription data associated with the UE 145. For instance, the UDM 126 may store multiple subscriber profiles, where each subscriber profile may include a respective collection of information that describes one or more characteristics, one or more preferences, one or more services that a respective subscriber is entitled to use, one or more communication priority levels that may be assigned to the respective subscriber, and/or one or more operating conditions associated with the service(s) that the subscriber is entitled to use. The AUSF 124 may query the UDM 126 using the UE identifier for subscription data that is associated with the UE 145, and the UDM 126 may return the subscription data that is associated with the UE 145. The subscription data may include at least some of the information stored in the subscriber profile of the UE 145, such as subscription plan information (e.g., service(s) that the UE 145 is entitled to use), a communication priority level, operating condition(s) associated with the service(s) that the UE 145 is entitled to use, or any combination thereof. As one example, the subscription data retrieved by the UDM 126 may indicate that the UE 145 is subscribed to a priority service plan that allows for high-priority communication and/or may specify, as an operating condition, that the subscription is contingent on the high-priority communications being associated with emergency situations. As another example, the subscription data may indicate a maximum priority level that is available to the UE 145, ensuring that the network resources are allocated in accordance with the subscriber’s plan. Other examples of communication priority levels include high priority for emergency services, medium priority for services like voice and video calls, low priority for standard data traffic, premium priority for subscribers with enhanced service plans, and background priority for non-urgent communications such as software updates.

Based on the retrieved subscription data, the AUSF 124 may determine whether the UE 145 is eligible for the requested priority service. If the subscription data indicates that UE 145 meets criteria to use the requested priority service, the AUSF 124 may proceed to authenticate the UE 145 and approve the priority service request.

As at least part of authenticating the UE 145, the AUSF 124 may select a configuration for the priority WLAN connection. For example, the subscription data associated with the UE 145 may include a maximum priority level that the UE 145 may use for the priority WLAN connection. Based at least in part on the maximum priority level being lower than the requested priority, the AUSF 124 may derive an assigned priority as the maximum priority level. Alternatively, based at least in part on the maximum priority level being higher than the requested priority, the AUSF 124 may derive the assigned priority as the requested priority level. The AUSF 124 selecting a configuration for the priority WLAN connection may ensure that the network configures the priority WLAN connection in accordance with the subscriber’s entitlements and network policies.

As shown by FIG. 1F and reference number 168, the AUSF 124 may send an HTTP message to the NSWOF 134, where the HTTP message is a second HTTP message that indicates an acknowledgment to the first HTTP message that indicates the priority WLAN connection request as described with regard to FIG. 1C. That is, the second HTTP message may be an authentication message that indicates that the UE 145 has been verified and confirmed for access to the priority WLAN connection. Alternatively, or additionally, the AUSF 124 may send an authentication confirmation to one or more other NFs in the core network 105 that may be involved in setting up the priority connection.

In some aspects, the second HTTP message may include information that is based at least in part on the subscription data and/or the configuration derived from the AUSF 124. For instance, the second HTTP message may contain a UE identifier for the UE 145, such as an IMSI or a temporary identifier. Alternatively, or additionally, the second HTTP message may include the assigned priority level for the priority WLAN connection derived by the AUSF 124. The second HTTP may include additional information, such as the maximum priority level authorized for the subscriber and/or one or more operating conditions or policies that are associated with the priority service. Providing the additional information may enable the NSWOF 134 to accurately map HTTP priority parameters to the appropriate DRMP as described with regard to FIG. 1G, ensuring that the priority WLAN connection is configured correctly and efficiently.

As shown by FIG. 1G and reference number 170, the NSWOF 134 may send a diameter message to the gateway device 110, where the diameter message is a second diameter message that authenticates and/or acknowledges the priority WLAN connection request in the first diameter message described with regard to FIG. 1B. The NSWOF 134 may generate the second diameter message based at least in part on mapping the assigned priority indicated in the HTTP message from the AUSF 124 to a DRMP AVP. Alternatively, or additionally, the NSWOF 134 may map additional parameters to the second diameter message, such as session duration operating condition (e.g., a session duration limit) or data rate operation condition (e.g., a data rate limit).

As another examples, the NSWOF 134 may also include one or more QoS parameters in the second diameter message, where the one or more QoS parameters indicate a level of service quality that is an operating condition for the priority WLAN connection (e.g., a latency threshold, a jitter threshold, and/or a packet loss threshold). For instance, the NSWOF 134 may extract the QoS parameter(s) from the second HTTP message, may map the QoS parameter(s) to respective (corresponding) diameter AVPs, and may include the respective (corresponding) diameter AVPs in the second diameter message to ensure that the priority WLAN connection adheres to the service quality operating conditions. Other examples may include the NSWOF 134 extracting one or more security parameters from the HTTP message and mapping the security parameter(s) to respective diameter AVPs, and/or the NSWOF 134 extracting one or more network resource allocation parameters from the HTTP message and mapping the network resource allocation parameter(s) to respective diameter AVPs in the second diameter message. Extracting and mapping the various parameters from the second HTTP message to the second diameter message may ensure that the priority WLAN connection is established with the correct priority, quality, security, and resource allocation as supported by the core network 105 and indicated by the subscriber profile.

As shown by FIG. 1H and reference number 172, the gateway device 110 may use the second diameter message from the NSWOF 134 to generate a priority mapping between the core network 105 and the priority WLAN connection with the UE 145. For instance, the gateway device 110 may convert the DRMP attributes indicated in the second diameter message into corresponding priority parameters for priority WLAN connection management. As one example, for a priority WLAN connection that is an IPsec tunnel, the gateway device 110 may convert the DRMP attributes into DSCP values in the IP headers to ensure that high-priority data packets are given precedence over lower-priority packets. Alternatively, or additionally, the gateway device 110 may map the DRMP attributes to GTPv2 bearer QoS parameters that are used by the core network 105, such as by setting higher priority levels for certain bearer channels to ensure that priority communications receive an appropriate amount of bandwidth and low data transfer latency. To illustrate, the second diameter message may indicate a priority value (e.g., an MPS priority value), and the gateway device 110 may map the priority value to one or more BRC parameters and/or a bearer context information element (IE) of a GTPv2 message. The gateway device 110 converting the DRMP attributes to corresponding priority parameters for priority WLAN connection management (e.g., IPsec tunnel parameters and/or GTPv2 parameters) may ensure that priority levels assigned by the core network 105 to communications are accurately reflected in the data traffic handling of the WLAN connection.

As one example, mapping a priority level (e.g., an MPS priority level) into one or more DSCP values may ensure IP packet priority in the transport network. To illustrate, DSCP values may be embedded within an IP packet header to indicate a level of service quality and/or a priority level to apply to the packet as the packet is processed through various stages of a network (e.g., a data path and/or a user-plane path). Assigning higher DSCP values to higher priority communications enables a network infrastructure to prioritize the higher-priority communications, resulting in low data-transfer latency and high reliability in a high-priority service, such as a high-priority service used for emergency communications. Alternatively, or additionally, mapping the priority level to DSCP values may ensure that the associated priority designated at an application layer is consistently maintained throughout a network.

As shown by FIG. 1I and reference number 174, the gateway device 110 may establish and manage a priority-based WLAN connection with the UE 145 using the core network 105. For instance, the gateway device 110 may establish, as the priority WLAN connection, an IPSec tunnel with the UE 145 using the mapped priority parameters described with regard to FIG. 1H to ensure that data packets associated with high-priority services (e.g., MPS) are given precedence over lower-priority traffic (e.g., standard traffic).

As one example, the gateway device 110 may establish, as the priority WLAN connection, an IPsec tunnel with the UE 145 by initiating the IPsec tunnel establishment process with the UE 145 based at least in part on exchanging one or more IKEv2 messages to negotiate encryption keys and security protocols. Alternatively, or additionally, the gateway device 110 may contemporaneously communicate with the core network 105 using GTPv2 messages to manage control plane information. To illustrate, the gateway device 110 may send, via a GTPv2 message, a Create Session request to the core network 105 that indicates a request to establish bearer channels that will carry the data plane traffic. Alternatively, or additionally, the core network 105 may respond, via a GTPv2 message, with a Create Session response that includes one or more bearer context parameters and/or one or more QoS parameters. The gateway device 110 may map the assigned priority described above to the GTPv2 bearer QoS parameter(s), ensuring that the data plane traffic through the IPsec tunnel is handled according to the priority levels. That is, the gateway device 110 may configure the bearer channels using the assigned priority setting and/or adjusting QoS values in an IP header to align with the assigned priority levels.

Alternatively, or additionally, the gateway device 110 may initiate a connection management procedure, such as an IPSec tunnel management procedure, that specifically prioritizes communications through the priority WLAN connection. As at least part of managing the communications, the gateway device 110 may map an associated priority (e.g., an MPS priority and/or an assigned priority) to a DRMP AVP that is included in a diameter message associated with a communication being carried through the IPsec tunnel. The diameter message may be sent to the NSWOF 134, and the NSWOF 134 may translate the DMRP AVP to HTTP parameters as described herein. On a data path, the gateway device 110 may map the priority (e.g., the assigned priority and/or the MPS priority) to one or more general packet radio service tunneling protocol-user plane (GTP-U) messages and may establish one or more packet data unit (PDU) sessions with specified DSCP values for prioritization. Once the priority WLAN connection is created, the gateway device 110 may manage the associated communications through the priority WLAN connection with higher data transfer priority.

In some aspects, the gateway device 110 may establish separate connections for data traffic and control traffic by communicating with different entities/NFs within the core network 105. To illustrate, the gateway device 110 may establish a data traffic connection with the UPF/PGWu 138 using one or more GTPv2 protocol messages and the third connection 154, resulting in the establishment of one or more data plane traffic bearer channels. Alternatively, or additionally, the gateway device 110 may establish a control plane connection with the SMF/ PGWc 136 to manage session control information. Establishing the separate connections for data plane traffic and control plan information ensures that data traffic is efficiently routed through the UPF/PGWu 138, while the SMF/PGWc 136 handles the signaling and control messages used for session management and QoS enforcement.

Based at least in part on establishing the priority WLAN connection, the gateway device 110 may continuously manage the data traffic, such as by monitoring data flow and dynamically adjusting priority settings based on real-time network conditions (e.g., network congestion, data transfer latency, packet loss, and/or throughput) and subscriber operating conditions (e.g., service level agreement (SLA) compliance, QoS parameters, data usage limits, and/or security protocols). To illustrate, the gateway device 110 may implement a feedback mechanism that receives network performance metrics, such as latency, jitter, and packet loss, and adjusts the priority parameters accordingly. The feedback mechanism may include communication(s) with one or more other NFs, such as the PCF 128, to obtain updated policy rules and subscriber profiles. By leveraging the priority mapping and dynamic management capabilities, the gateway device 110 may increase a reliability of prioritized communication services over WLAN connections. For example, the gateway device 110 may dynamically adjust priority settings based on the real-time network conditions to enable optimal performance for high-priority communications, such as by adjusting DSCP values, reallocating bandwidth, and/or implementing priority queuing, to ensure that high-priority services are maintained even during network congestion.

In some implementations, the gateway device 110 may support the establishment of multiple prioritized WLAN connections (e.g., multiple IPSec tunnels with different priority levels) for a single UE. For instance, the gateway device 110 may establish a high-priority WLAN connection tunnel for voice communications and a low-priority WLAN connection for regular data traffic. By managing multiple WLAN connections with distinct priority levels, the gateway device 110 may ensure that prioritized communications satisfy operating conditions without compromising the overall network performance in a flexible and scalable solution.

The number and arrangement of devices and networks shown in FIGS. 1A-1I are provided as an example. In practice, there may be additional devices and/or networks, fewer devices and/or networks, different devices and/or networks, or differently arranged devices and/or networks than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) of example environment 100 may perform one or more functions described as being performed by another set of devices of example environment 100.

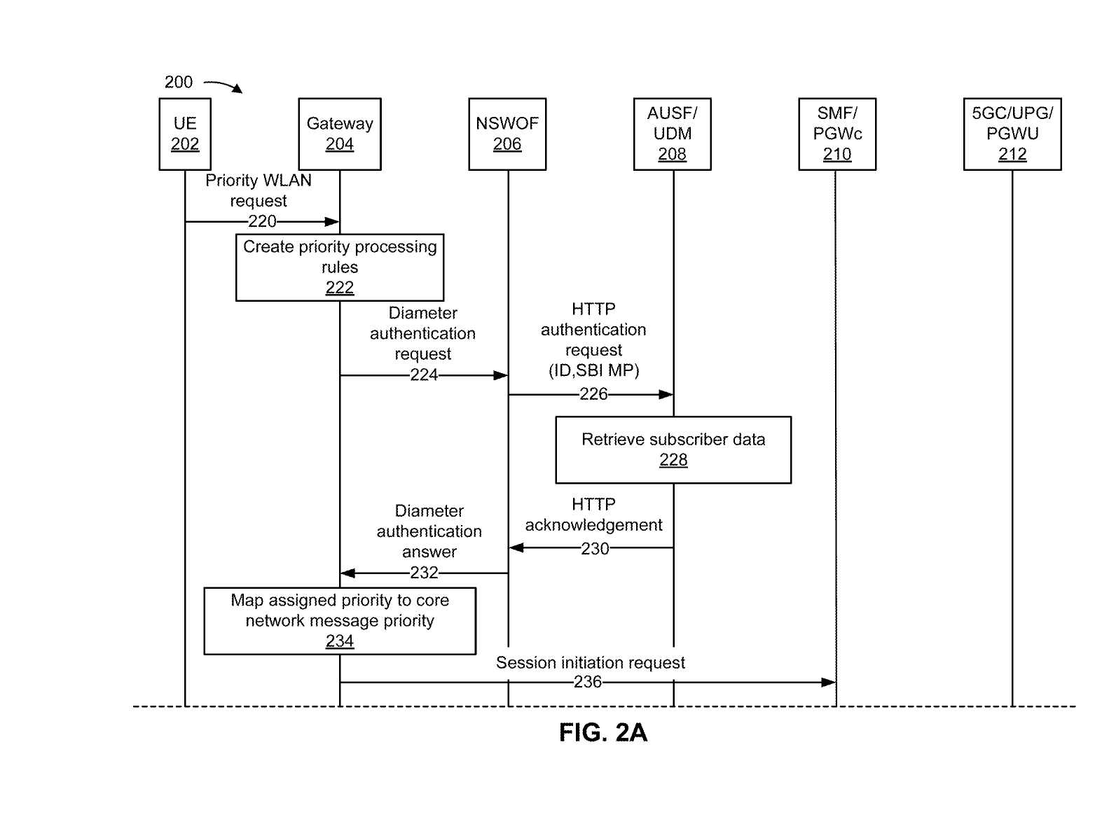

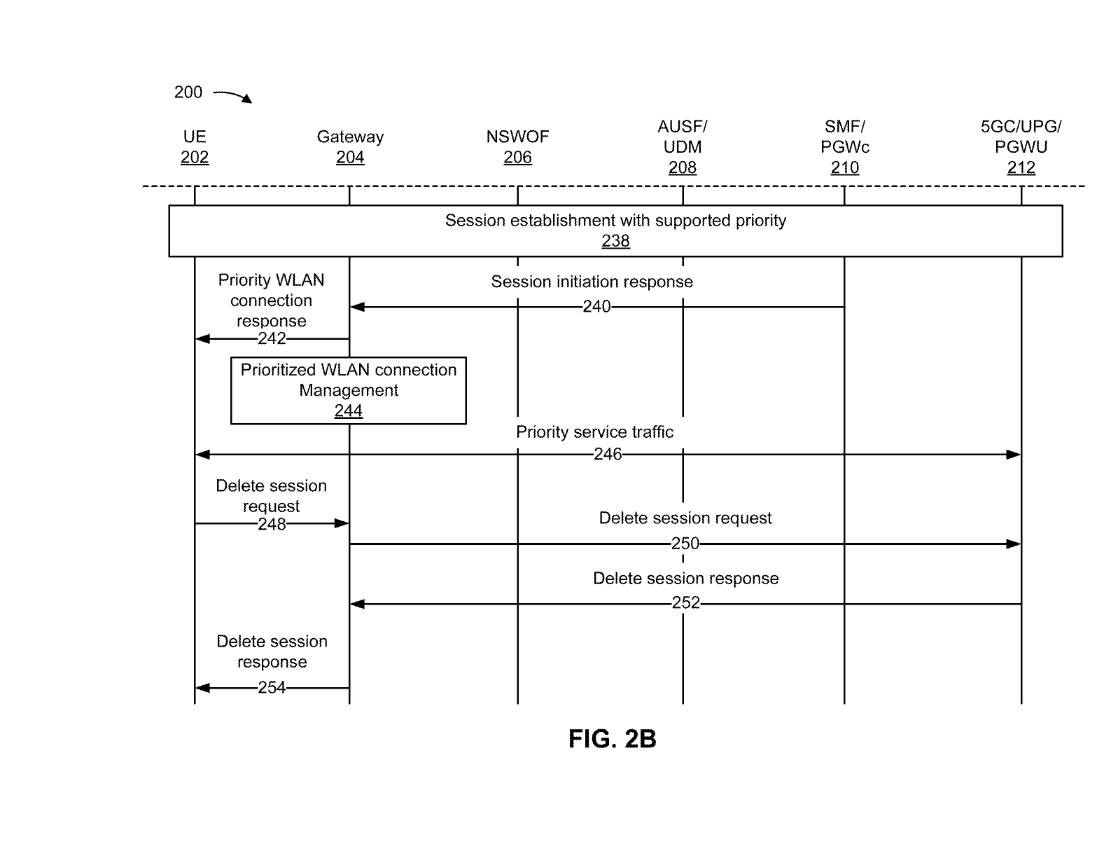

FIGS. 2A and 2B collectively illustrate an example 200 of a call flow diagram for establishing a prioritized WLAN connection using services provided by a cellular core network. In some aspects, the call flow diagram described with regard to the example 200 includes interactions and exchanges between a UE 202 (e.g., the UE 145), a gateway 204 (e.g., the gateway device 110), an NSWOF 206 (e.g., NSWOF 134), an AUSF/UDM 208 (e.g., the UDM 126 and the AUSF 124), an SMF/PGWc 210 (e.g., the SMF/PGWc 136), and a 5GC/UPF/PGWu 212 (e.g., the UPF/PGWu 138).

As shown by reference number 220 in FIG. 2A, a UE 202 may initiate a request for a priority WLAN connection, such as by transmitting a priority WLAN connection request (e.g., an MPS priority request) to a gateway 204. For instance, the UE 202 may transmit, and the gateway 204 may receive, the priority WLAN connection request using a WLAN connection between the UE 202 and the gateway 204. In some aspects, the request may include one or more parameters associated with the priority WLAN connection request, such as a requested priority level and/or a UE identifier, examples of which are described with regard to FIGS. 1A-1I. In some cases, the UE 202 may send a preformatted message that instructs the gateway 204 to initiate a priority service procedure, such as an IKEv2 message that includes a specific priority attribute (e.g., a specific priority level) and/or a standardized format that includes one or more predefined fields that carry information used to establish a secure connection with priority handling. Additionally, or alternatively, the UE 202 may transmit a dynamically generated request for the priority WLAN connection, such as a request that is dynamically generated by the UE 202 based at least in part on current network conditions and/or user input, such as an IKEv2 message that includes real-time metrics (e.g., current latency, bandwidth, and packet loss) and user-specified urgency (e.g., an emergency situation).

As shown by reference number 222, the gateway 204 may create, establish, or update one or more priority processing rules based on the priority WLAN connection request. In some aspects, the gateway 204 may create or establish the priority processing rule(s) based at least in part on receiving the priority WLAN connection request. For instance, the gateway 204 may analyze a requested priority level in the priority WLAN connection request and create or establish a processing rule that uses the requested priority level. Additionally, or alternatively, the gateway 204 may update one or more parameters internal to the gateway 204 that govern how the gateway 204 handles the priority WLAN connection request and/or an associated priority service, such as by adjusting one or more internal configurations to prioritize traffic according to the requested priority level. In some cases, the gateway 204 may map the requested priority level to a DRMP AVP to ensure that the priority information is accurately conveyed and processed by one or more NFs within the core network and that the requested priority level is consistently maintained as the request is processed through the various NFs.

As shown by reference number 224, the gateway 204 may send a first diameter message, such as a diameter authentication request, to an NSWOF 206. For example, the gateway 204 may send the first diameter message to the NSWOF 206 as described with regard to FIG. 1A to initiate the process of establishing a priority WLAN connection. The first diameter message may include the requested priority level and/or the UE identifier indicated by the UE 145 in the priority WLAN request described with regard to reference number 220. In some aspects, the gateway 204 may include additional detail in the first diameter message. To illustrate, the priority WLAN connection request from the UE 202 may be an MPS priority request, and the gateway 204 may include information from the MPS priority request in the first diameter message, such as specific service operating conditions and/or session priority parameters. Examples of service operating conditions may include a guaranteed minimum bandwidth, a guaranteed maximum data transfer latency, an encryption standard, and/or prioritized access to network resources. Examples of session priority parameters include a maximum allowable bandwidth, a data transfer latency threshold, a jitter threshold, a packet loss threshold, and/or a session duration threshold. Additionally, or alternatively, the gateway 204 may map information from the priority WLAN connection request to the first diameter message, such as by embedding information within standard diameter protocol fields and/or in one or more DRMP AVPs, to ensure that the information is properly formatted for processing by the NSWOF 206.

As shown by reference number 226, the NSWOF 206 may send an HTTP message, such as an HTTP authentication message, to an AUSF/UDM 208. For instance, the NSWOF 206 may generate the HTTP message by mapping information included in one or more DRMP AVPs to corresponding HTTP headers or fields such that the priority information in the first diameter message is accurately conveyed to the AUSF/UDM 208 in the HTTP message. In some cases, the NSWOF 206 may include the requested priority level and/or the UE identifier in the HTTP message (e.g., using an HTTP format). Additionally, or alternatively, the NSWOF 206 may map and include additional information in the HTTP message, such as specific service operating conditions and/or session priority parameters that are associated with an MPS priority request. The NSWOF 206 may send the HTTP message to the AUSF/UDM 208 using the message bus 140 (e.g., an SBI) as described with regard to FIG. 1A.

As shown by reference number 228, the AUSF/UDM 208 may retrieve subscription data (e.g., subscriber session priority data) using the UE identifier indicated in the HTTP message from the NSWOF 206. For instance, as described with regard to FIG. 1E, the AUSF may query the UDM for subscription data, and the UDM may access a database to retrieve the subscription data. The subscription data may include any combination of subscription plan information, one or more communication priority levels, session priority data, security service information, and/or operating conditions associated with the services that the UE 202 is entitled to use. The AUSF may query the UDM using the message bus 140, and the UDM may return the subscription data to the AUSF using the message bus 140. In some cases, the AUSF may use the subscription data to derive a configuration for the priority WLAN connection, such as by obtaining or deriving a maximum allowable priority level for the UE 202 from the subscription data to derive an assigned priority level. Other examples may include the AUSF obtaining or deriving one or more operating conditions specific to the UE 202, and/or security operating conditions that are specific to the UE 202. For instance, a time-based operating condition may specify that the priority WLAN connection is only available during emergency situations, while a tiered prioritization based on user categorization may assign higher priority levels to first responders compared to regular subscribers. Additionally, security operating conditions may include encryption operating conditions mandating the use of advanced encryption standard (AES)-256 encryption for data transmission, and authentication operating conditions specifying that multi-factor authentication must be used to access the priority service.

The AUSF may configure the priority WLAN connection by including parameters in the HTTP message sent to the NSWOF 206 that are set to one or more values of the configuration selected by the AUSF. For example, the AUSF may set an SBI MP parameter to indicate the assigned priority level based on user categorization, such as “SBI MP=high” for first responders. Additionally, the AUSF may include an “encryption_type” parameter set to “AES-256” and an “authentication_method” parameter set to “multi-factor” to configure the security operating conditions for the priority WLAN connection.

As shown by reference number 230, the AUSF/UDM 208 may send a second HTTP message, such as an HTTP acknowledgment message, to the NSWOF 206. The second HTTP message may include one or more parameters, such as an assigned priority, an encryption type, and an authentication mode, that are configured by the AUSF as described with regard to reference number 228. By communicating an acknowledgment, the AUSF/UDM 208 may confirm that the priority WLAN connection request has been processed and approved using the configuration indicated in the acknowledgment. Alternatively, or additionally, the acknowledgment may indicate confirmation that subscription data for the UE 202 has been verified and that the UE 202 is eligible for the requested priority service.

As shown by reference number 232, the NSWOF 206 may send a second diameter message (such as a diameter authentication answer that is a response to the diameter authentication request described with regard to reference number 224) to the gateway 204. In some aspects, the NSWOF 206 may generate the second diameter message based at least in part on mapping information, such as an assigned priority level, in the second HTTP message described with regard to reference number 230 to one or more DRMP AVPs. However, the NSWOF 206 may map other information from the HTTP message to the second diameter message, such as an encryption type, an authentication method, and/or session information in respective diameter AVPs.

As shown by reference number 234, the gateway 204 may map the assigned priority to the core network message priority. For instance, the gateway 204 may translate the received DRMP attributes into corresponding core network priority parameters. For example, the gateway 204 may map a high-priority DRMP attribute indicated in a DRMP AVP to a DSCP value of 46, which is typically used for expedited forwarding (EF) to ensure low latency and high priority for critical traffic. The gateway 204 may apply the DSCP value to packets that are forwarded through the core network, resulting in high-priority traffic receiving corresponding QoS treatment by the core network. As another example, the gateway 204 may map the high-priority DRMP attribute to a specific QCI value, such as QCI 1, which is used for conversational voice traffic, ensuring that the priority level assigned by the core network is accurately reflected in the handling of data traffic. Additionally, or alternatively, the gateway 204 may communicate the QoS parameters to the core network using a GTPv2 message, such as a Create Session request, which includes the mapped DSCP value and a QoS Class Identifier (QCI) value, such as QCI 1, to reflect the priority level assigned by the core network.

As shown by reference number 236, the gateway 204 may send a session initiation request to an SMF/PGWc 210, such as by sending a “Create Session Request” message to the SMF/PGWc 210 via the message bus 140 (e.g., an SBI) and using a GTPv2 message and/or a GTPv2 protocol. The session initiation request may indicate a request to establish the priority WLAN connection and may indicate configuration information for the priority WLAN connection, such as configuration information indicated in the second diameter message described with regard to reference number 232 and/or the core network message priority mappings performed by the gateway 204. Examples include the assigned priority, security information, and/or one or more session parameters.

The call flow diagram described with regard to the example 200 is continued in FIG. 2B. As shown by reference number 238, any combination of the UE 202, the gateway 204, the NSWOF 206, the AUSF/UDM 208, the SMF/PGWc 210, and/or the 5GC/UPF/PGWu 212 may interact to establish a session with the supported and/or configured priority. For example, based at least in part on receiving the session initiation request from the gateway 204 as described with regard to reference number 236, the SMF/PGWc 210 may process the request, such as by extracting the assigned priority level and/or one or more QoS operating conditions. The SMF/PGWc 210 may set up one or more bearer channels by configuring QoS parameters such as the QoS Class Identifier (QCI), Allocation and Retention Priority (ARP), and Guaranteed Bit Rate (GBR). In some cases, to ensure secure communications, the SMF/PGWc 210 may configure one or more security parameters, including encryption and authentication methods, as indicated by the session initiation request. The SMF/PGWc 210 may coordinate with the UPF/PGWu 212 to allocate network resources and/or to establish routing paths for the priority traffic. For example, the SMF/PGWc 210 may establish a control path with the gateway 204 and other NFs to manage signaling and session control information, ensuring proper session management and QoS enforcement. Additionally, or alternatively, the SMF/PGWc 210 may set up a data traffic path through the UPF/PGWu 212 to handle data transmission between the UE 202 and a DN/AF (e.g., the DN/AF 115), where the data traffic path is configured with at least the assigned priority. In some cases, the SMF/PGWc 210 may exchange signaling messages with the gateway 204 and other NFs to confirm the configuration details. Additionally, or alternatively, the NSWOF 206 may send an acknowledgment message to the AUSF/UDM 208, confirming that the priority mapping has been successfully applied.

As shown by reference number 240, the SMF/PGWc 210 may send a session initiation response message to the gateway 204, such as a Create Session Response message. In some aspects, the session initiation response message may include one or more security parameters to use for establishing the priority WLAN connection (e.g., for establishing an IPsec tunnel). By including security parameter(s), the SMF/PGWc 210 may enable the gateway 204 to establish a secure communication channel between the UE 202 and a core network (e.g., the core network 105). Additionally, or alternatively, the session initiation response message may include other information, such as one or more QoS parameters (e.g., in addition to an assigned priority) for the newly established session, also enabling the gateway 204 to manage the session based on the specified QoS operating conditions.

As shown by reference number 242, the gateway 204 may send a priority WLAN connection response message, such as by sending an MPS priority response message in a scenario in which the UE 202 requests an MPS connection. The priority WLAN connection response message may include one or more parameters used by the core network to establish the priority WLAN connection, such as a maximum allowable bandwidth for the priority session that mitigates the session exceeding allocated resources. Other parameters may include a session duration threshold, a data rate threshold, one or more security parameters such as encryption methods and authentication protocols, or any combination thereof. Sending such parameters to the UE may ensure that the priority session is managed effectively, providing the resources and security that may be used for high-priority communications. Additionally, the priority WLAN connection response message may include confirmation of the assigned priority level and any specific instructions or configurations for the UE to maintain the priority connection. In some aspects, the gateway 204 may transmit the priority WLAN connection response message in an IKEv2 message or another suitable protocol to convey these parameters.

As shown by reference number 244, the gateway 204 may manage the prioritized WLAN connection, such as by managing an IPSec tunnel. For example, the gateway 204 may dynamically adjust one or more traffic shaping policies within the prioritized WLAN connection to ensure that high-priority traffic receives an appropriate amount of bandwidth and low latency, resulting in compliance with QoS operating condition(s) for high-priority communications. Additionally, or alternatively, the gateway 204 may monitor network performance metrics such as latency, jitter, and packet loss, and make real-time adjustments to a configuration of the prioritized WLAN connection to increase a reliability of the prioritized connection and/or to reduce data transfer latency. Examples of configuration parameters that may be adjusted include a DSCP value to prioritize particular types of traffic, and a Maximum Transmission Unit (MTU) size to increase packet transmission efficiency and reduce fragmentation. In some aspects, the gateway 204 may adjust the traffic shaping policies based on the assigned priority, such as by setting bandwidth thresholds to allocate more bandwidth to high-priority traffic and implementing priority queuing to ensure that high-priority packets are transmitted before lower-priority packets. Actions described with regard to reference number 244 may be iteratively or continuously performed to maintain optimal performance and reliability of the prioritized WLAN connection.

As shown by reference number 246, priority service traffic may be transmitted via the established prioritized WLAN connection, which may include data traffic from the UE 202 and/or data traffic to the UE 202. As described with regard to reference number 244, the data traffic transmitted through the prioritized WLAN connection may be continuously and/or iteratively monitored to ensure that the data traffic is processed according to the assigned priority level and/or does not exceed the allocated resources.

As shown by reference number 248, a delete session request may be initiated by the UE 202. For example, the UE 202 may initiate the delete session request based at least in part on receiving user input that indicates to terminate the prioritized WLAN connection and/or based at least in part on the UE 202 detecting a condition that warrants termination, such as the completion of a high-priority task. The transmission of a delete session request may enable the network to free up resources when a session has been completed or terminated. In some aspects, the delete session request may include an indication of why the session is being terminated, such as the end of an emergency, handover to a different network, or the completion of the data transfer. Providing a context for the session termination may enable a network to manage resources more efficiently. For example, if the delete session request indicates that the session is being terminated due to the end of an emergency (e.g., an end to using an emergency data traffic type), the network can prioritize reallocating the freed resources to other high-priority tasks or UEs that are associated with the emergency data traffic type.

Additionally, or alternatively, the delete session request may trigger the gateway 204 and/or other NFs to release the allocated resources and update their records to reflect the termination of the session. Accordingly, as shown by reference number 250, the delete session request may be propagated through various NFs of the network, and one or more corresponding delete session response messages may be sent back to confirm the session termination as shown by reference number 252 and reference number 254. In some aspects, a delete session response message may include confirmation that all associated resources have been released by the respective NF, resulting in efficient management of the network resources. Additionally, or alternatively, the delete session response message may include logging information for recording purposes.

As indicated above, FIGS. 2A and 2B are provided as an example. Other examples may differ from what is described with regard to FIGS. 2A and 2B.

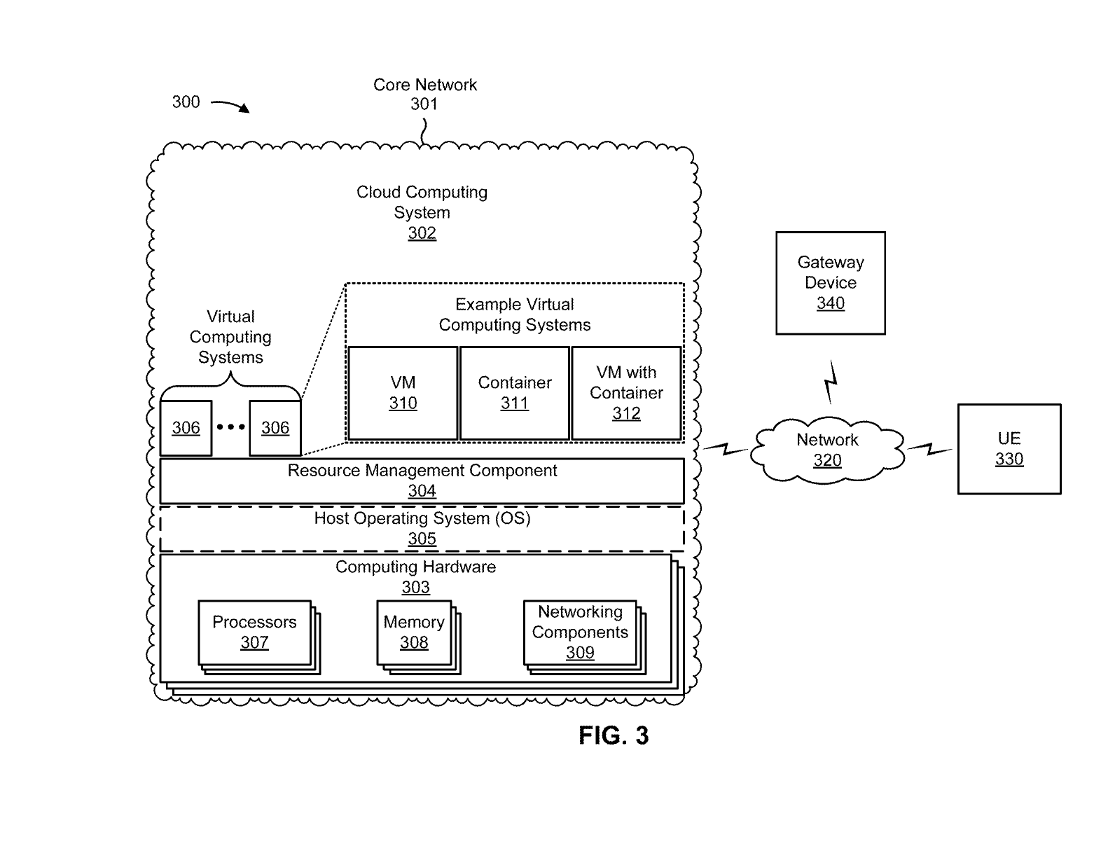

FIG. 3 is a diagram of an example environment 300 in which systems and/or methods described herein may be implemented. As shown in FIG. 3, environment 300 may include a core network 301, which may include one or more elements of and/or may execute within a cloud computing system 302. The cloud computing system 302 may include one or more elements 303-312, as described in more detail below. As further shown in FIG. 3, environment 300 may include a network 320, a gateway device 330 (e.g., the gateway device 110 described with regard to FIGS. 1A-1I and/or the gateway device 204 described with regard to FIGS. 2A-2B, and/or a UE device 340 (e.g., the UE 145 described with regard to FIGS. 1A-1I and/or the UE 202 described with regard to FIGS. 2A-2B). While FIG. 3 illustrates the gateway device 330 being separate from the core network 301, other examples may include the gateway device 330 being part of the core network 301 (e.g., as a separate device or included as at least part of the cloud computing system 302). Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources used to execute applications on a guest operating system (e.g., within the virtual computing system 306) or the host operating system 305.

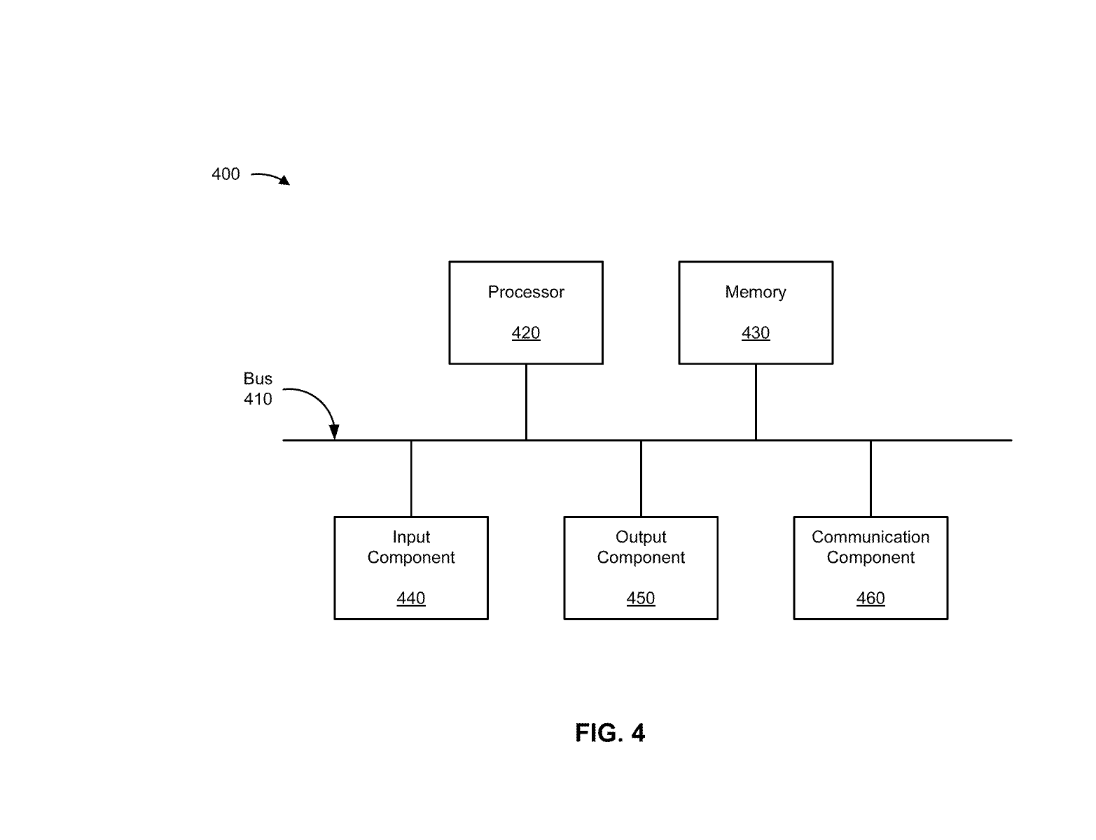

Although the core network 301 may include one or more elements 303-312 of the cloud computing system 302, may execute within the cloud computing system 302, and/or may be hosted within the cloud computing system 302, in some implementations, the core network 301 may not be cloud-based (e.g., may be implemented outside of a cloud computing system) or may be partially cloud-based. For example, the core network 301 may include one or more devices that are not part of the cloud computing system 302, such as device 400 of FIG. 4, which may include a standalone server or another type of computing device. The core network 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with establishing a prioritized WLAN connection using cellular core network services. The device 400 corresponds to one or more of a gateway device 110, a UE 145, one or more computing devices that are utilized by a DN/AF 115, and/or one or more computing devices that are utilized by a core network 105. In some implementations, a gateway device 110, a UE 145, one or more computing devices that are utilized by a DN/AF 115, and/or one or more computing devices that are utilized by a core network 105 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

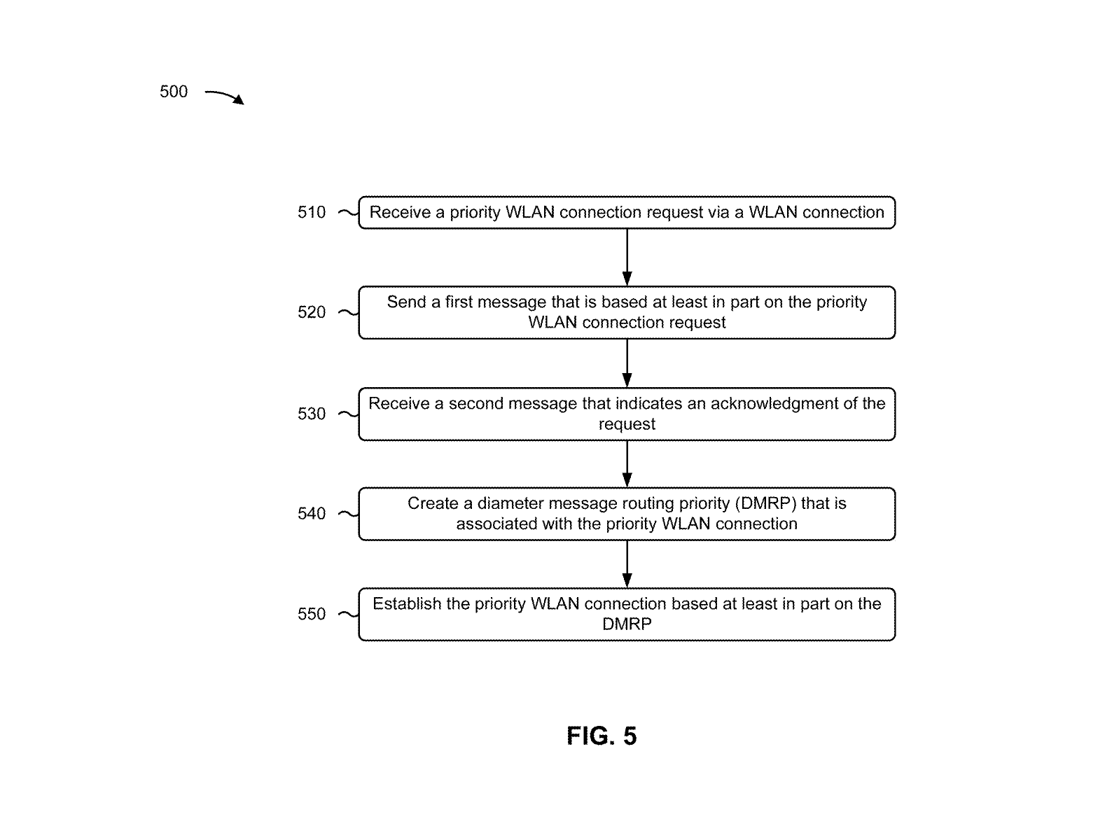

FIG. 5 is a flowchart of an example process 500 associated with establishing a prioritized WLAN using cellular core network services. In some implementations, one or more process blocks of FIG. 5 may be performed by a device (e.g., gateway device 110 or a gateway 204). In some implementations, one or more process blocks of FIG. 5 may be performed by another device or a group of devices separate from or including the device, such as a core network (e.g., a core network 105 or core network 301), a UE (e.g., a UE 145 or a UE 202), and/or DN/AF (e.g., a DN/AF 115). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving a priority WLAN connection request via a WLAN connection (block 510), such as a request to establish an MPS connection. To illustrate, the device may be a gateway device, and the gateway device may receive the priority WLAN connection request from a UE using a WLAN connection between the gateway device and the UE. In some aspects, the priority WLAN connection request may indicate a request to establish a priority WLAN connection with the UE. Alternatively, or additionally, the priority WLAN connection request may indicate a requested priority and/or to establish the priority WLAN connection using the requested priority, as described above.

As further shown in FIG. 5, process 500 may include sending a first message that is based at least in part on the priority WLAN connection request (block 520). In some aspects, the first message may indicate or include the request for the priority WLAN connection and/or the requested priority. For example, the device may map one or more parameters from the priority WLAN connection request to one or more parameters of the first message, and may send the first message to one or more NFs of a core network as described above. As one non-limiting example, the first message may be a diameter message, and the device may map parameters from the priority WLAN connection request to one or more diameter parameters (e.g., one or more DRMP AVPs).

As further shown in FIG. 5, process 500 may include receiving a second message that indicates an acknowledgment of the request (block 530). For example, the device may receive a second message that indicates an acknowledgment of the request. Alternatively, or additionally, the second message may indicate an assigned priority for the priority WLAN connection, as described above. In some cases, the second message may be a diameter message, such as in a scenario where the first message is a diameter message.

As further shown in FIG. 5, process 500 may include creating a DMRP that is associated with the priority WLAN connection (block 540). For example, the device may create the DMRP based at least in part on an assigned priority indicated in the second message, as described above. The device may create the DMRP to manage communications via the priority WLAN connection.

As further shown in FIG. 5, process 500 may include establishing the priority WLAN connection request based at least in part on the DMRP (block 550). For example, the device may establish the priority WLAN connection request based at least in part on the DMRP, as described above. Alternatively, or additionally, the device may establish the priority WLAN connection by using one or more GTPv2 communications with a core network.

As at least part of receiving a priority WLAN connection request, process 500 may include receiving the priority WLAN connection request as an IKE authentication request message (e.g., an IKEv2 authentication message). In some cases, the first message (e.g., a first diameter message) that is generated by the device may include one or more priority attributes that are indicated by the priority WLAN connection request. Example priority attributes include any combination of the requested priority (e.g., a data traffic priority), a QCI, an ARP, a DSCP value, and/or one or BRC parameters. The request for the priority WLAN connection may, in some examples, include a request to establish an IPsec tunnel. Accordingly, process 500 may include establishing, as the priority WLAN connection, an IPsec tunnel with the UE, and establishing the IPsec tunnel may include establishing the IPsec tunnel using an assigned priority indicated in the second message (e.g., a second diameter message). For example, the assigned priority may be associated with one or more assigned priority attributes, and the device may configure the IPsec tunnel (and/or may be configured to manage data traffic communicated via the IPsec tunnel) using the assigned priority attributes. To illustrate, the device may be a gateway device and, as at least part of performing process 500, the gateway device may configure the IPsec tunnel, and/or may manage data communications through the IPsec tunnel, using the assigned priority and/or associated assigned priority attributes.

Process 500 may include authenticating the UE for one or more priority services that are provided by a core of a cellular network. That is, the priority WLAN connection request may be authenticated or authorized based at least in part on authenticating that the UE has access to the priority service(s) of the core. An example of authenticating the UE may include communicating with, and/or using services provided by, one or more NFs of a core, such as any combination of a UDM, an AUSF, and/or an NSWOF as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

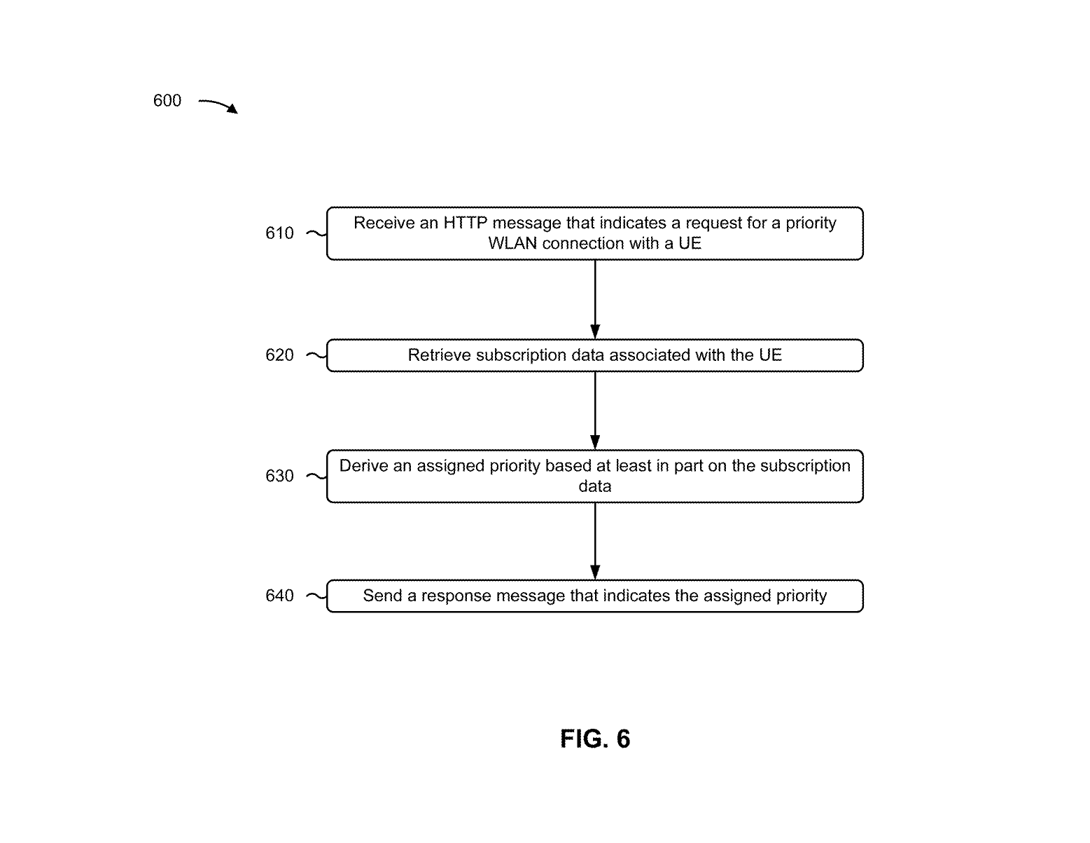

FIG. 6 is a flowchart of an example process 600 associated with establishing a prioritized WLAN connection using cellular core network services. In some implementations, one or more process blocks of FIG. 6 may be performed by a device (e.g., a core network 105 or a core network 301). In some implementations, one or more process blocks of FIG. 6 may be performed by another device or a group of devices separate from or including the device, such as a UE (e.g., a UE 145 or a UE 202) or a gateway device (e.g., a gateway device 110 or a gateway 204). Additionally, or alternatively, one or more process blocks of FIG. 6 may be performed by one or more components of device 400, such as processor 420, memory 430, input component 440, output component 450, and/or communication component 460.

As shown in FIG. 6, process 600 may include receiving an HTTP message that indicates a request for a priority WLAN connection request with a UE (block 610). For example, the device may receive an HTTP message that indicates a request for a priority WLAN connection request with a UE. To illustrate, the device may receive the HTTP message using an SBI at the core network. In some cases, the priority WLAN connection request may be based at least in part on a WLAN connection, such as a WLAN connection between the UE and a gateway device of the core network. Alternatively, or additionally, the HTTP message may indicate a UE identifier that is associated with the UE, a requested priority for the priority WLAN connection request, or both, as described above.

As further shown in FIG. 6, process 600 may include retrieving subscription data associated with the UE (block 620). For example, the device may retrieve subscription data associated with the UE, as described above. To illustrate, the device may use the UE identifier indicated in the HTTP message to query a UDM.

As further shown in FIG. 6, process 600 may include deriving an assigned priority based at least in part on the subscription data (block 630). For example, the device may derive an assigned priority based at least in part on the subscription data, as described above. Alternatively, or additionally, the device may derive the assigned priority using the requested priority and the subscription data, such as by deriving the assigned priority based at least in part on a maximum priority level indicated by the subscription data as described above.

As further shown in FIG. 6, process 600 may include sending a response message that indicates the assigned priority (block 640). For example, the device may send a response message that indicates the assigned priority, as described above.

The HTTP message received may be a first HTTP message, and in sending the response message, process 600 may include sending a second HTTP message that indicates the response message. As one example, an AUSF at a core network may send the second HTTP response to an NSWOF at the core network as described above. Alternatively, or additionally, process 600 may include translating the second HTTP message to a diameter message. To illustrate, the NSWOF may translate one or more priority attributes indicated in the second HTTP message to one or more DMRP AVPs as described above, and the NSWOF may send the diameter message to a gateway device. Accordingly, sending the response message may include a first core network NF (e.g., an AUSF) sending an HTTP message to a second core network NF (e.g., an NSWOF), and the second core network NF sending a diameter message that is a translation of the HTTP message (e.g., a translation from HTTP to diameter messaging).

Process 600 may include validating the priority WLAN connection request using an AUSF of the core network and a subscriber profile as described above. For instance, the subscription data may be retrieved by the AUSF by querying a UDM at the core network, such as by including a UE identifier indicated in the HTTP message that includes the priority WLAN connection request. The subscriber profile may include subscription data that indicates information associated with the UE, one or more communication priority levels that are associated with the UE, one or more session priorities, and/or one or more operating conditions. For instance, the subscriber profile may indicate that a UE is subscribed to a priority service plan that allows for high-priority communication and/or may specify, as an operating condition, that the subscription is contingent on the high-priority communications being associated with emergency situations. As another example, the subscriber profile may indicate a maximum priority level that is available to the UE. Accordingly, process 600 may include mapping subscriber profile information, such as session priority information (e.g., a maximum allowable bandwidth, a data transfer latency threshold, a jitter threshold, a packet loss threshold, and/or session duration threshold), to one or more commensurate parameters in an HTTP message (e.g., commensurate priority parameters in the HTTP message).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving a priority wireless local area network (WLAN) connection request to establish a priority WLAN connection with a user equipment (UE) based at least in part on a requested priority;
sending a first message that is based at least in part on the priority WLAN connection request, the first message indicating the request and the requested priority;
receiving a second message that indicates an acknowledgment to the request and an assigned priority;
creating a diameter message routing priority (DMRP) that is associated with the priority WLAN connection based at least in part on the assigned priority; and
establishing the priority WLAN connection based communications with a core network and the DMRP.

2. The method of claim 1, wherein receiving the priority WLAN connection request comprises receiving an Internet Key Exchange authentication request message.

3. The method of claim 1, wherein the first message is a diameter message that includes one or more priority attributes that are indicated by the priority WLAN connection request.

4. The method of claim 1, wherein establishing the priority WLAN connection comprises:
establishing an Internet protocol security (IPsec) tunnel with the UE based at least in part on one or more priority attributes that are associated with the assigned priority.

5. The method of claim 1, further comprising:
authenticating the UE for one or more priority services provided by a core of a cellular network, the authenticating being based at least in part on using one or more services provided by at least one of:
a unified data management (UDM) function of the core network,
an authentication server function (AUSF) of the core network, or
a non-seamless WLAN offload function of the core network.

6. The method of claim 1, further comprising:
managing data communications through the priority WLAN connection based at least in part on the assigned priority.

7. A method, comprising:
receiving, at a core network, a hypertext transfer protocol (HTTP) message that indicates a request for a priority wireless local area network (WLAN) connection with a user equipment (UE), the HTTP message indicating a UE identifier that is associated with the UE and a requested priority for the priority WLAN connection;
retrieving subscription data associated with the UE based at least in part on the UE identifier;
deriving an assigned priority based at least in part on the requested priority and the subscription data; and
sending a response message that indicates the assigned priority.

8. The method of claim 7, wherein the HTTP message is a first HTTP message, and
wherein sending the response message comprises:
sending, using an authentication server function of the core network, a second HTTP message that indicates the response message.

9. The method of claim 8, further comprising:
translating, using a non-seamless wireless offload function (NSWOF), the second HTTP message to a diameter message
wherein sending the response message comprises:
sending the diameter message to a gateway device.

10. The method of claim 9, wherein translating the second HTTP message to the diameter message comprises:
mapping the assigned priority to a diameter routing message priority (DRMP) attribute-value pair (AVP).

11. The method of claim 7, wherein retrieving the subscription data comprises:
querying a unified data management function for a subscriber profile using the UE identifier.

12. The method of claim 11, wherein the subscriber profile comprises at least one of:
subscription information associated with the UE, or
one or more communication priority levels associated with the UE.

13. The method of claim 11, further comprising:
validating the request using an authentication server function of the core network and the subscriber profile.

14. The method of claim 11, wherein the HTTP message is a first HTTP message, and
wherein the method further comprises:
mapping one or more session priorities indicated by the subscriber profile to one or more priority parameters in a second HTTP message based at least in part on a predefined mapping scheme.

15. A device, comprising:
one or more processors configured to:
receive a priority wireless local area network (WLAN) connection request via a WLAN connection, the priority WLAN connection request indicating a request to establish a priority WLAN connection with a user equipment (UE) based at least in part on a requested priority;
send a first message that is based at least in part on the priority WLAN connection request, the first message indicating at least the request and the requested priority;
receive a second message that indicates an acknowledgment of the request and an assigned priority;
create a routing priority message that is associated with the priority WLAN connection based at least in part on the assigned priority; and
establish the priority WLAN connection based at least in part on communications with a core network.

16. The device of claim 15, wherein the one or more processors, to receive the priority WLAN connection request, are configured to receive an Internet Key authentication request message.

17. The device of claim 15, wherein the first message is a first diameter message and includes one or more priority attributes that are indicated by the priority WLAN connection request.

18. The device of claim 15, wherein the one or more processors, to establish the priority WLAN connection, are configured to:
establish an Internet Protocol Security (IPsec) tunnel with the UE based at least in part on one or more priority attributes that are associated with the assigned priority.

19. The device of claim 15, wherein the one or more processors are further configured to:
authenticate the UE for one or more priority services provided by a core of a cellular network, the authenticating being based at least in part on using one or more services provided by at least one of:
a unified data management (UDM) function of the core network,
an authentication server function (AUSF) of the core network, or
a non-seamless WLAN offload function of core network.

20. The device of claim 15, wherein the one or more processors are further configured to:
manage data communications through the priority WLAN connection based at least in part on the assigned priority.
